(19) United States
(12) Patent Application Publication
(10) Pub. No.: US 2015/0120572 A1
(43) Pub. Date: Apr. 30, 2015

(54) LOCATION BASED MOBILE DEPOSIT SECURITY FEATURE

(71) Applicant: Nitro Mobile Solutions, LLC, Tampa, FL (US)

(72) Inventor: Peter C. Slade, Tampa, FL (US)

(73) Assignee: Nitro Mobile Solutions, LLC, Tampa, FL (US)

(21) Appl. No.: 14/143,772

(22) Filed: Dec. 30, 2013

Related U.S. Application Data
(60) Provisional application No. 61/895,509, filed on Oct. 25, 2013.

(51) Int. Cl. G06Q 20/32

(52) U.S. Cl. CPC G06Q 20/3224; G06Q 20/3223
USPC 705/73; 705/42

(57) ABSTRACT

A mobile deposit application including a remotely accessible bank administrative interface module for setting a plurality of geographic-based security rules, a rules module communicative coupled to the bank administrative interface module, the rules module comprising bank-definable location parameters for enabling mobile deposit based on the geographic location of a mobile device, a geolocation module communicatively coupled to the rules module, the geolocation module receives coordinates of the mobile device and applies said coordinates to the rules module to determine if mobile deposit features are enabled or disabled and an exception presentation module communicatively coupled to the rules module, the exception presentation module displaying notifications to the mobile device responsive to a disabling of the mobile deposit features responsive to the geolocation module reporting the mobile device falls outside the bank-definable location parameters.

### CROSS REFERENCE TO RELATED APPLICATION

This application claims priority to currently pending U.S. Provisional Patent Application No. 61/895,509, entitled “Location Based Mobile Deposit Security Feature”, filed on Oct. 25, 2013, the contents of which are herein incorporated by reference.

### BACKGROUND OF THE INVENTION

1. Field of the Invention

This invention relates to systems, methods, and software for implementing location based authentication to determine the safety of financial and business transactions from a mobile device.

2. Background

Although there are numerous electronic payment methods including credit cards, EFT transactions, email-based transfers (such as those facilitated under the PAYPAL brand) and the like, the printed paper check is still commonly in use. For many individuals, it is burdensome to either mail or transport these checks to a bank branch for deposit.

Those same individuals dealing with paper checks frequently have smart phone devices which have both secure Internet connectivity, imaging capabilities and GPS location technology. Mobile deposit applications enable a banking customer to take an image of the front and back of a check and then send the data to their bank electronically. This is commonly known as remote deposit capture or RDC. However, as with many technical advances, new opportunities for fraud arise.

The Check 21 Act of 2004 authorized digital versions of paper checks for processing and enumerated procedures required of check imaging regardless of which channel the payment comes through. However, with RDC there is one notable difference that paves the way for new threats . . . the consumer holds onto the check, which gives criminals the power to serial deposit. A criminal could open accounts at a number of banks and make multiple deposits with the same check. Some companies are developing databases that will let bank participants receive real-time notice of duplicate checks. However, the convenience and mobility of modern banking lends itself to the risk that criminals may connect and exploit vulnerabilities in RDC from anywhere in the world.

RDC security features enumerated by Bob Meara in a Jun. 20, 2013 post on the CELENT BANKING BLOG asserted RDC is more secure than branch deposits for the following reasons:
Deposit review conducted by trained specialists in the back-office.
Check codelines are captured and verified in real-time. Suspects are flagged immediately for review and possible hold.
Back-office personnel often have an enterprise wide view of account trends and activity.
Optional real-time interface to fraud and positive pay systems. Multiple risk filters examine all items in real-time, flagging unusual activity or suspect items for operator review.
Transit items are presented for clearing and settlement throughout the day, accelerating payment and returns.
Funds availability may be negotiated based on customer risk ratings as part of a unique deposit services agreement.

However, few of the current security features of RDC technology take advantage of the ability to locate where the RDC transaction is occurring. Individual banks typically understand the geographic zones in which their customers exist. Therefore, there is an opportunity to use the geolocation potential of the RDC device with the institutional knowledge of the bank to minimize the potential for RDC fraud. U.S. Patent Publication 20130259357 describes using geolocation settings in Paragraph 0031 to authorize or deny a RDC mobile deposit based on rules determined by a financial institution. However, the '357 publication is silent as to setting a plurality of remote zones in which a RDC mobile deposit would be authorized. The '357 further does not suggest or teach combining other factors discussed below with multiple geographic zones to enhance both security and customer convenience.

What is needed is a method and computer-implemented application to empower banks to set geographic limitations in a granular fashion to enable or disable features of RDC in concert with the relative risk of fraud.

There is a further need in the art to provide functionality to enable RDC in completely separate geographical zones.

There is a further need in the art to provide a granular level of multiple geolocation methods to enable or disable RDC under various circumstances.

### SUMMARY OF THE INVENTION

The present invention includes both a method and a software application enabled on non-transitory computer readable media to perform instructions on a computer (typically a web server portal networked to back-office support servers). The invention advances the state of the art by providing mobile deposit authorization based on multiple, remote zones that represent a diminished risk of fraud. As a method, the steps of authorizing remote data capture mobile deposits include providing a remotely accessible encrypted bank administrative portal. This is typically a web server URL accessed with the HTTPS prefix which is a secure socket layer (SSL) connection. Through this portal, a banking representative configures a mobile device application having a mobile deposit function to electronically capture images of a paper check and submit them for electronic deposit to a bank account. The bank representative does not need to have programming experience to manage the configuration settings.

The bank representative generates the geolocation rules in a number of ways. He can set a single geographic point and then specify a radius to create a first geographic zone that is circular. Alternatively, he may also set a plurality of geographic points to form a polygon shape for a second geographic zone. The zones may be set as “permitted” or as “denied” for mobile deposit functionality. As shown in the figures discussed below, multiple geographic zones may be set to provide the bank with granular fraud security based on their own institutional knowledge of their customer's habits. For example, customers may be grouped into civilian residential communities as well as foreign military bases.

The bank representative may also determine whether to deny mobile deposit functionality based on whether the mobile device running the application has been rooted or jail-broken. If the operating system of the mobile device is compromised this may represent a new and significant opportunity for fraud. Once the bank representative is satisfied that the application is configured and tested the application through a simulator within the same portal the application (or “app” as mobile software is referred to) is published to an “app store” which distributes the application either free or at a fixed price. Typically, a bank will distribute its mobile app for free to encourage continued patronage of its institution by providing mobile banking features to its customers.

In an embodiment of the invention, the bank customer with the mobile device installs the application and then launches it on the operating system of his mobile device. The mobile device establishes a secure connection between the application installed on the customer's mobile device and a rules server storing configuration data set by the administrative portal. This secure connection typically would be over a Wi-Fi, 4G or 3G connection. The application may optionally detect whether the customer's mobile device has been rooted or jail-broken to deny or limit the mobile deposit function. The rules server determines whether the location of the customer's mobile device permits, denies or limits a mobile deposit attempt. The rules server does this by using geolocation techniques such as retrieved cellular geolocation, IP geolocation, GPS geolocation or a combination thereof. It should be noted that the server connection cannot always be verified at the time the application is started. Therefore, the application may receive a configuration profile from the rules server that is applied at the device level with the set restrictions. If the application is launched again without retrieving the configuration profile from the rules server then it uses the previous configuration profile it successfully retrieved.

An embodiment of the invention includes the step of accessing a bank customer database containing address data for a plurality of bank customers. The bank customer database is communicatively coupled (e.g., “networked”) to the rules server wherein the geographic zones are automatically generated based on the address data. The address data may include ZIP codes, city, state or similar data to create a plurality of finely-tuned geographic zones to permit mobile deposits.

Another embodiment of the invention includes a fraud alert module communicatively coupled to the rules server. Responsive to a geographically identified fraud attempt, a blocked geographic zone is automatically generated centered on the location of the fraud attempt. A predetermined wait constant is accessed by the fraud alert module wherein the blocked geographic zone is disabled after a duration of time defined by the wait constant has expired after the fraud attempt was first identified. A manual override routine may be provided to disable the blocked geographic zone prior to the expiration of the wait constant.

Rather than strictly limiting mobile deposits to geographic zones and device rooting, an embodiment of the invention also takes into consideration the amount of the deposit to make automatic and intelligent risk assessments. In this embodiment a first predetermined threshold amount is used in conjunction with a first geographic zone and a second predetermined threshold amount is used in conjunction with a second geographic zone wherein the first amount is higher than the second amount and the first zone represents a lower fraud risk than the second zone.

For example, if the user is within 1 mile of his home bank branch he may deposit up to $5,000. However, if he is between 1 and 10 miles from his home bank branch he may only deposit up to $2,500. Between 10 and 30 miles from home bank branch he may only deposit up to $1,000. Beyond 30 miles from home bank branch he cannot use the mobile deposit function. Rather than setting the amounts as fixed constants, an embodiment of the invention automatically derives the first and second amounts from the current funds on deposit by a user attempting to make the mobile deposit. In yet another embodiment, the first and second amounts are automatically derived from a banking history profile by the user attempting to make the mobile deposit, the banking history including the past frequency of check deposits made by the user previously. For example, if the user typically only makes one deposit each month for the last five years he may be limited to only 3 mobile deposits for the subsequent month. Provided those 3 mobile deposits are valid, he maximum mobile deposit limit may be raised to 6 and so-on. In another embodiment of the invention, location trends of deposits are captured and therefore used to increase the amount allowed based on the user being within a location they have previously established made deposits. For example, a user initially may only be allowed a maximum deposit amount of $2,500 within ten (10) miles from home but once the transaction completes successfully from that location then the dollar amount can be automatically increased. The amount of increase may be linked to the previous deposit amount (e.g., a 2X factor may increase the maximum deposit amount above to $5,000). Alternatively, the amount of increase may be linked to deposit frequency such as raising it $500 for each successful deposit (e.g., raised to $3,000). In yet another embodiment of the invention, the deposit amount may be raised by other factors such as total assets held by the banking customer and/or average monthly balance.

### DESCRIPTION OF THE DRAWINGS

FIG. 1 is a conceptual graphic user interface screen shot for a remote deposit capture configuration portal.

FIG. 2 is a conceptual graphic user interface screen shot for configuring screen settings for mobile deposit.

FIG. 3 is a conceptual graphic user interface screen shot for setting a first geographic zone for mobile deposit permissions.

FIG. 4 is a conceptual graphic user interface screen shot showing a geographic zone saved for mobile deposit permissions.

FIG. 5 is a conceptual graphic user interface screen shot for setting a second geographic zone for mobile deposit permissions.

FIG. 6 is a conceptual graphic user interface screen shot showing a plurality of geographic zones saved for mobile deposit permissions.

FIG. 7 is a conceptual graphic user interface screen shot for setting a third geographic zone for mobile deposit permissions.

FIG. 8 is a conceptual graphic user interface screen shot showing a plurality of geographic zones saved for mobile deposit permissions including the third geographic zone.

FIG. 9 is a conceptual graphic user interface screen shot for setting a fourth geographic zone for mobile deposit permissions.

FIG. 10 is a flowchart of the method according to a first embodiment of the invention.

FIG. 11 is a flowchart of the method according to a second embodiment of the invention.

FIG. 12 is a flowchart of the method according to a third embodiment of the invention.

FIG. 13 is a flowchart of the method according to a fourth embodiment of the invention.

### DETAILED DESCRIPTION OF THE PREFERRED EMBODIMENT

The present invention causes a mobile device to disable specific features and screens from access. Combining one or more of the methods below provides significant improvements to the security and protection of user's financial information limiting potential fraud.

When a user opens their mobile application an encrypted content synchronization occurs (if needed) between the server and the mobile app, immediately applying the latest security and content changes that have been set by the financial institution to the way the app performs.

One aspect of the security within the encrypted payload is the ability to specify one or more records of latitude, longitude, radius and the resulting action that should occur for being inside or outside of a zone. Latitude and longitude coordinates can also be used to create a drawn non-circular zones.

When the user accesses specific features within the app the device will use its GPS receiver to obtain latitude and longitude coordinates and then compare them to the geozones to determine if the device is inside or outside specified geographic regions. Once the device is determined to be in or out of a defined region the appropriate action to limit or expose functionality is taken by the mobile app. Zones can be layered. Using radius as an example:

TABLE 1

| Feature | Lat | Long | Radius | Action |
|---|---|---|---|---|
| Mobile Deposit | Large area | Large area | 5000 | Denied |
| Login | | | | |
| Mobile Deposit | Air-force Base | Air-force Base | 10 | Allowed |
| Login | | | | |

After reviewing the current location, settings and actions the device may determine that a specific feature of mobile deposit or mobile banking is either available for use or not available. The mobile app performs the check itself as there is no guarantee of good Internet via Wi-Fi or cellular networks to be able to rely on a server making the decision on whether the feature should be enabled or not.

If a feature is determined to be unavailable for use then the entire feature is inaccessible to the user and instead they receive a replacement screen for that specific feature informing the user that for their protection it has been disabled. The exact content of this message is one of the parameters content synchronized to the mobile app.

Transactions such as financial data, banking or mobile check deposits require a server component and in addition to the device determining if it's location is permitted or not, the server API also limits web API requests to the geographically derived IP address of the requesting device. To do this, the IP address of the device is received by the server and compared with a Geo-Location database to determine the general geographic area. A configurable wider radius is used on the server side as mobile devices move from tower to tower thereby causing their IP addresses to change.

If it is determined that the IP address originated outside of the allowed geographic area then the device is not serviced with the correct API request, instead returning a code to the app which is recognized as instructing the app to display that the feature has been disabled for their protection.

An example of how this combines with the above feature: An app may be within 20 miles of a south east regional bank's branch, located in downtown Tampa. The API for the app will only return API requests to a device with a requesting IP address that falls within the geographic area of Florida and Georgia. However, if the device is found to be within the geographic radius of an air-force base in Saudi Arabia then the feature will be enabled successfully and additionally the server will respond to API requests coming from that device's IP. Essentially a location based handshake has occurred. If the user left the approved geo region in Saudi Arabia then the feature would be disabled and additionally any other requests coming from that IP address (or others) would not be serviced.

Some users may elect to have disabled location gathering technology on their mobile devices, such as GPS receivers or Wi-Fi (which can be used for general location information). In those cases the app has a content setting that has been synchronized to the device that determines how the app's features should respond. For example, the feature may be disabled with the screen showing “We are unable to determine your location and therefore for your protection we have temporarily disabled this feature”

Additionally, we can detect if the device has been jail-broken in the case of iOS or rooted in the case of Android. If this is detected then the application hides specific features, and notifies the user that the feature has been disabled for their protection.

We prevent the login screens or any key features because a rooted or jail-broken device is capable of monitoring other apps on the mobile device and could intercept the typed username and password sending that to another server for someone to misuse later.

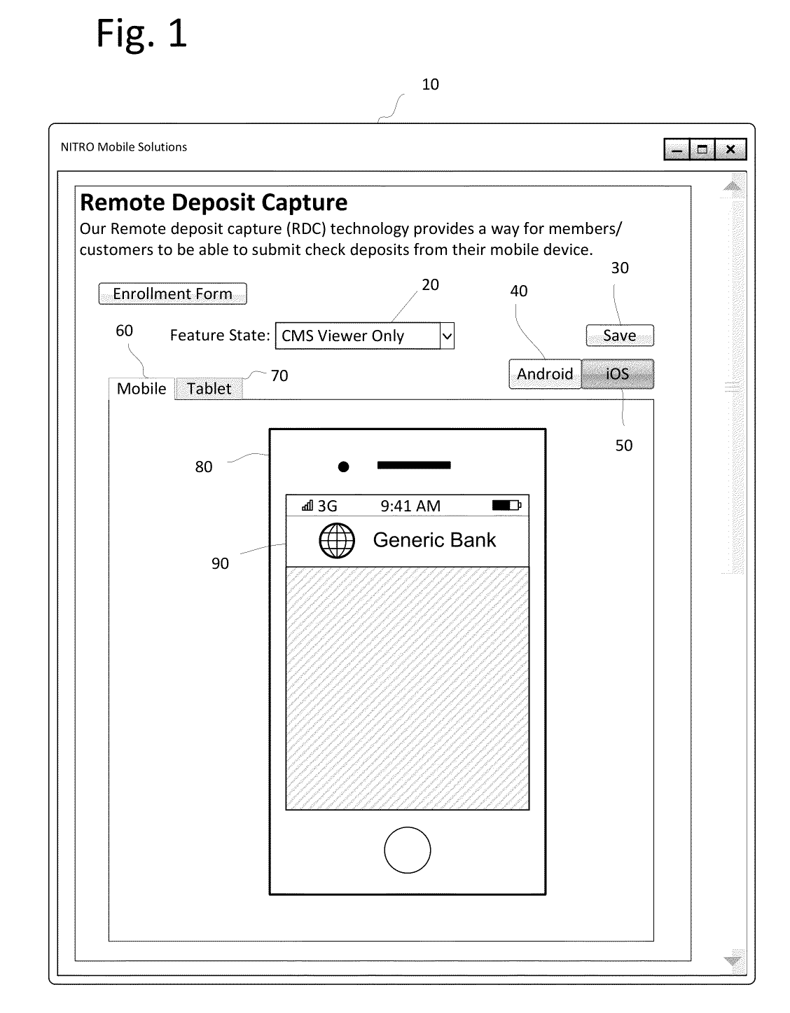

Turning now to FIG. 1, a graphic user interface (GUI) is shown as dialog box 10. This could be a local (on-premise) application but more likely a web browser interface through a SSL connection. Within dialog box 10 are a plurality of user controls. Dialog box 10 permits an authorized individual at the banking institution to set appearance and functional parameters of the RDC application. Feature state drop down 20 enables the end user to set various states of the mobile app including production, debugging or CMS viewer. Save button 30 saves changes and modifications made by end user. Device simulation 80 can be set for a mobile setting 60 or tablet setting 70. The operating systems may be toggled between those distributed under the IOS brand 50 and the ANDROID brand 40. A header graphic 90 is shown in device simulation 80.

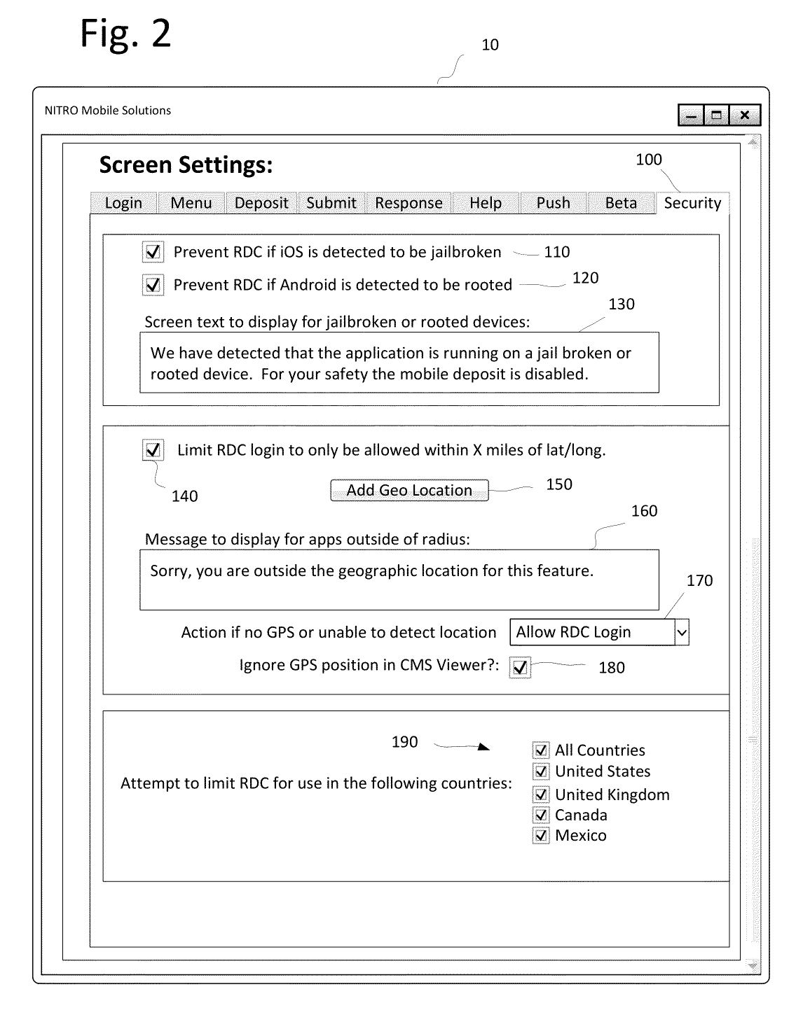

FIG. 2 shows options under security tab 100 within dialog box 10. Security tab 100 provide an additional collection of controls to setting rules for RDC mobile deposits. Checkbox control 110 prevents RDC if an iOS device is detected to be jail-broken. iOS jail-breaking is the process of removing the limitations on APPLE devices running the iOS operating system through the use of software and hardware exploits. Jail-breaking permits root access to the iOS operating system, allowing the download of additional applications, extensions, and themes that are unavailable through the official APPLE APP STORE.

Checkbox 120 prevents RDC is an ANDROID device is detected to be rooted. Android rooting is the process of allowing users of smartphones, tablets, and other devices running the ANDROID mobile operating system to attain privileged control (known as “root access”) within Android's subsystem. The process of rooting varies widely by device, but usually includes exploiting a security bug(s) in the firmware (i.e. in ANDROID) of the device, and then copying the su binary to a location in the current process's PATH (e.g. /system/xbin/su) and granting it executable permissions with the chmod command. Rooting is required for more advanced and potentially dangerous operations including modifying or deleting system files, removing carrier- or manufacturer-installed applications, and low-level access to the hardware itself (rebooting, controlling status lights, or recalibrating touch inputs.)

In the event either check box 110 or 120 are selected, a warning is displayed to the end user of the mobile device which can be authored in textbox control 130.

Checkbox 140 limits RDC login within a certain distance of a latitude or longitude. In FIG. 2, no latitude or longitude values have yet been entered. However, these can be added by clicking button 150. In the event the mobile device user is outside of the radius a message will display as set in textbox 160. Dropdown list control 170 permits the end user of the configuration to allow or deny RDC login if no GPS is available or the location of the mobile device cannot be resolved. While in CMS Viewer mode, selecting check box 180 will ignore the GPS position which is helpful for configuration and testing purposes. Checkbox array 190 can be set to limit RDC use in various countries.

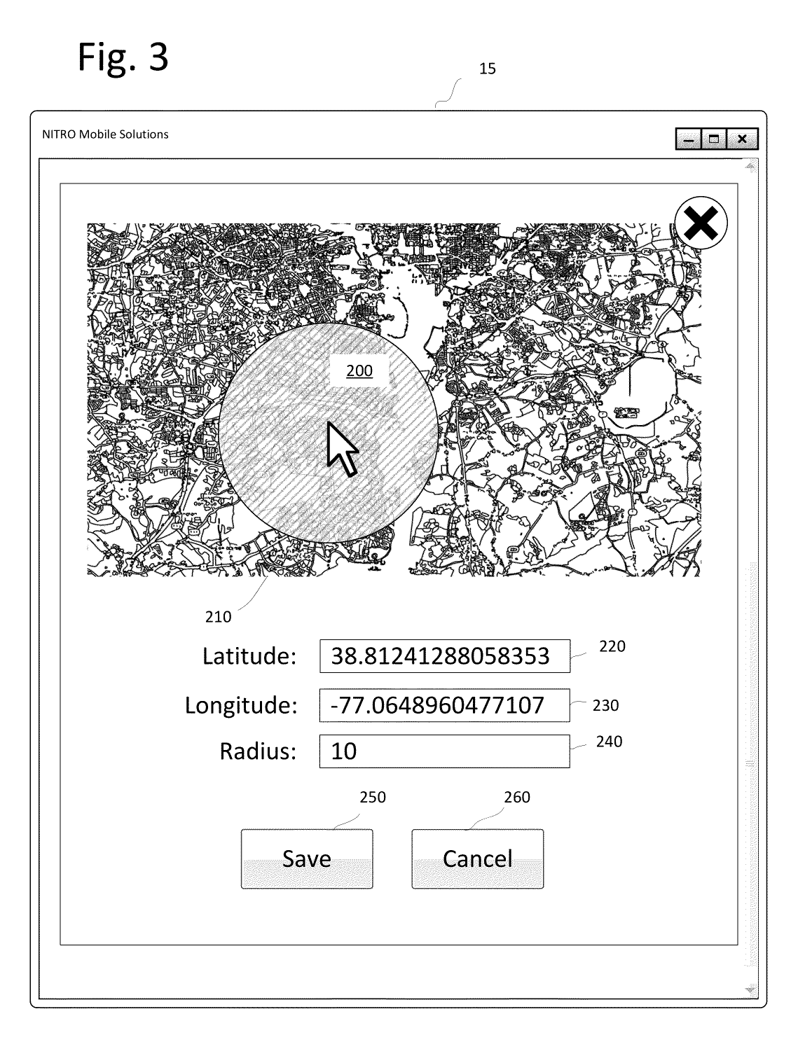

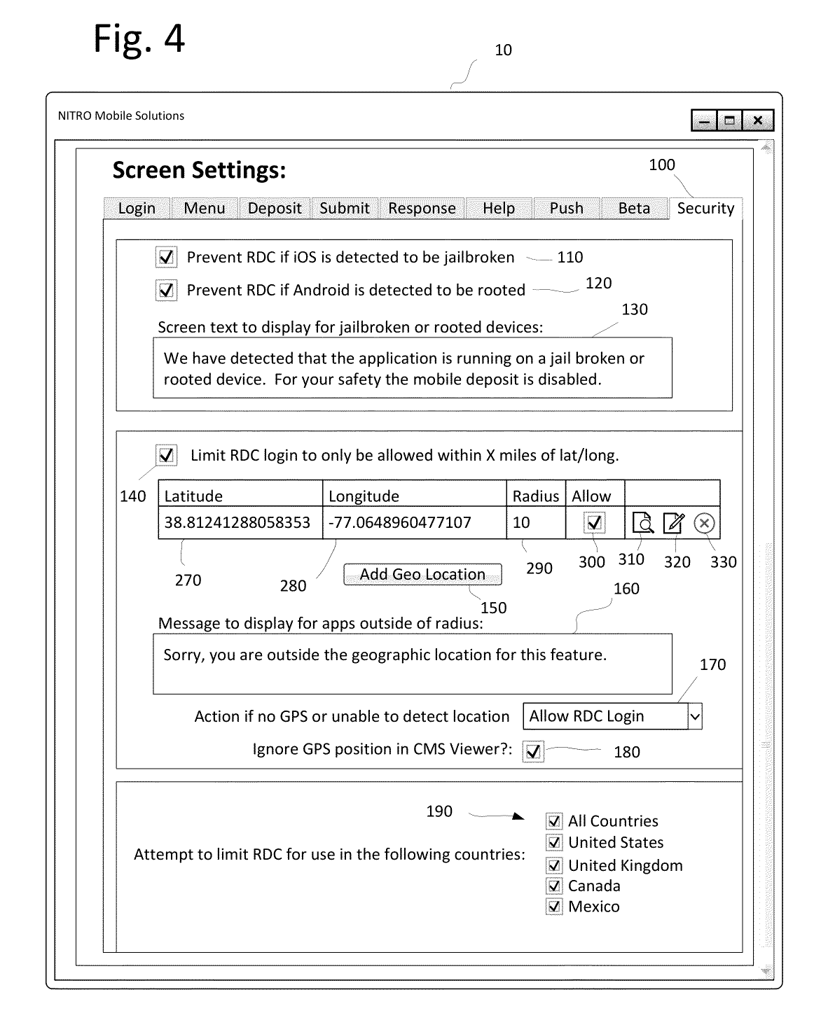

FIG. 3 shows dialog box 15 which is typically brought up in modal fashion responsive to clicking button 150 to add a location and radius. Map 210 is presented in an iframe and/or by an update panel using AJAX. An RDC zone 200 is graphically set by mouse pointer and textbox 220 displays latitude of zone 200's epicenter. Textbox 230 displays longitude of zone 200's epicenter. Textbox 240 displays radius from zone 200's epicenter to the outer boundary of zone 200. Zone 200 may be saved by save button 250 or discarded by cancel button 260. Upon clicking save button 250 the values in textboxes 220, 230 and 240 are saved and modal dialog box 15 closes and dialog box 10 is refreshed (as shown in FIG. 4) with a grid of values include latitude value 270, longitude value 280, radius value 290, allow Boolean value 300, preview icon 310, edit icon 320 and delete icon 330.

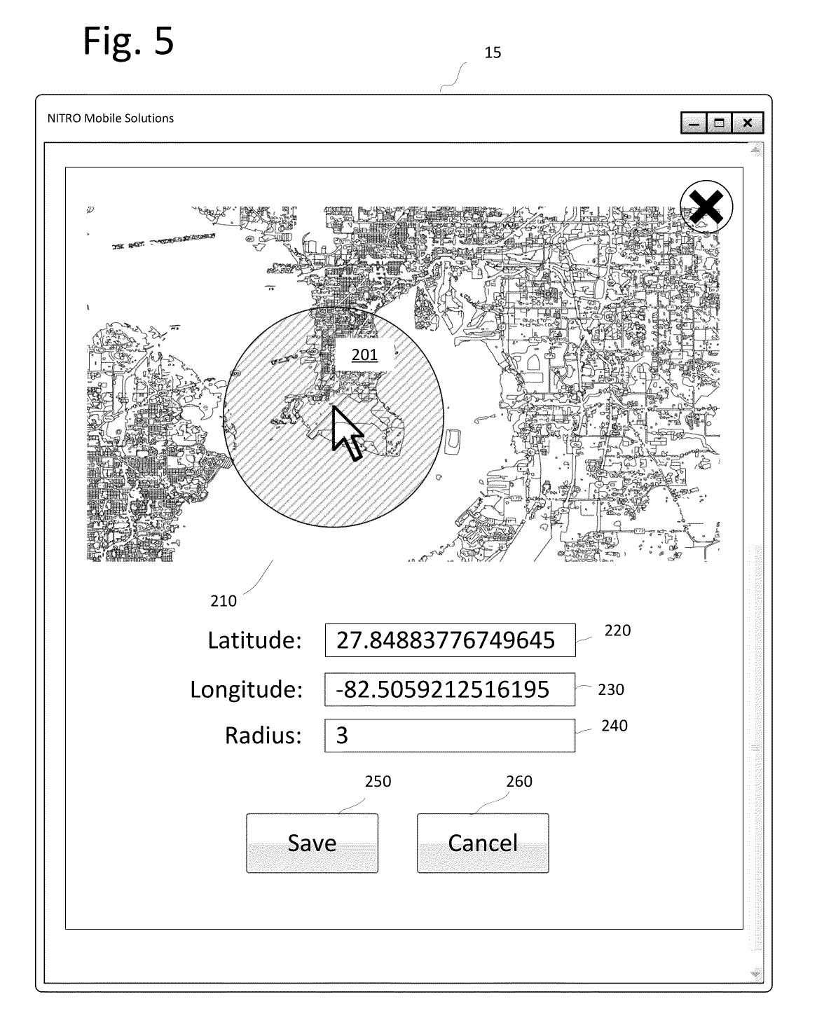

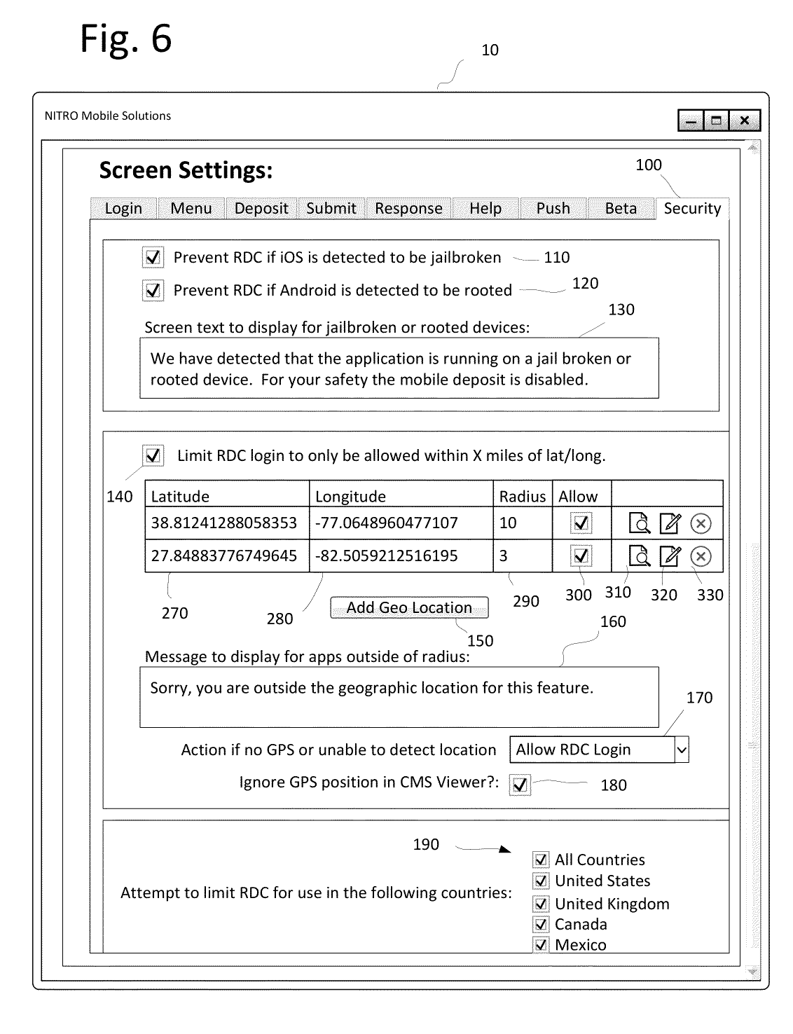

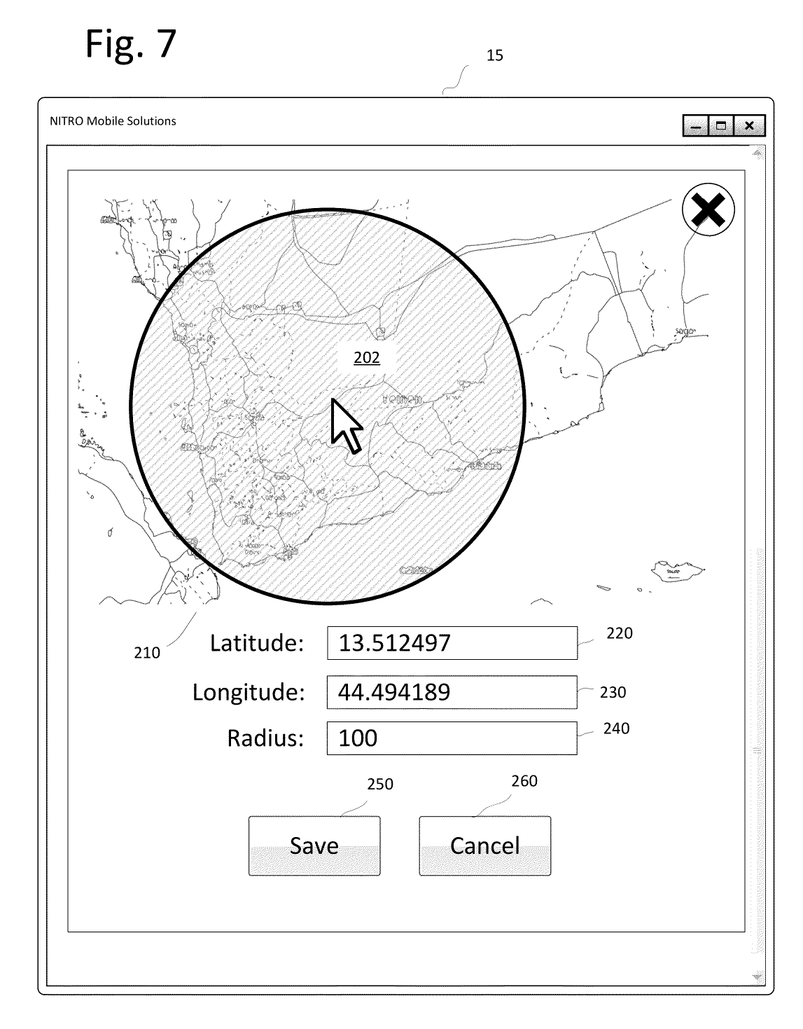

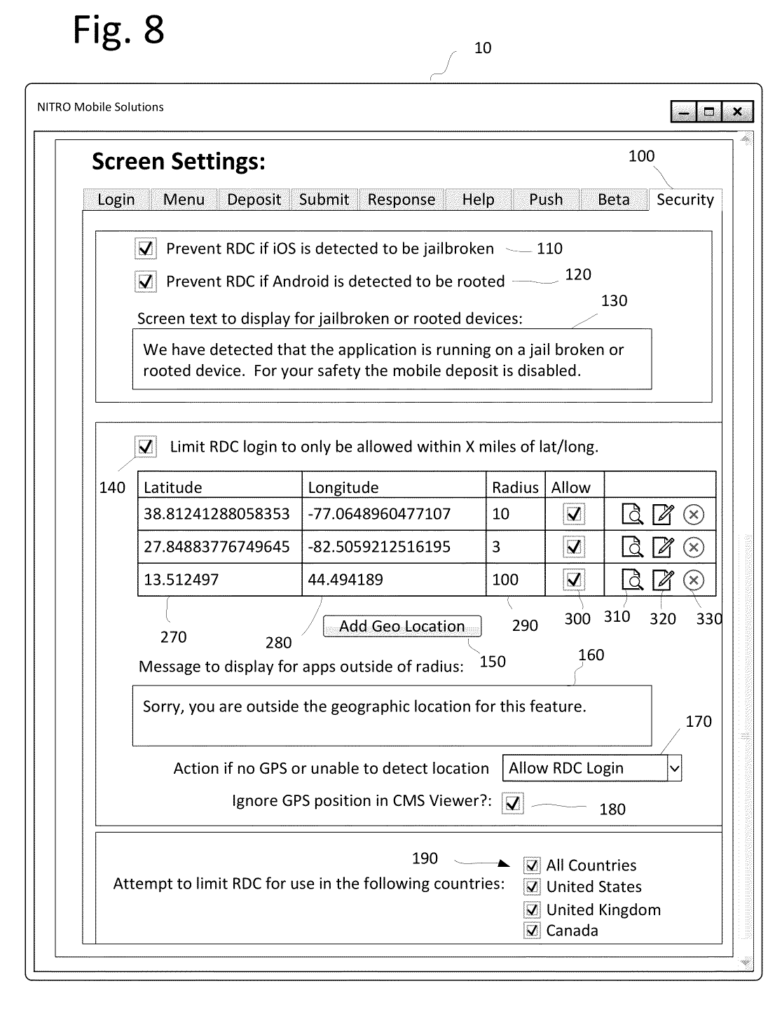

In FIG. 2, zone 200 was set upon Alexandria, Va. A bank may have a substantial customer base in Alexandria but also at MacDill Air Force Base in Tampa Fla. In such a circumstance, the end user setting the configuration for the bank would again click button 150 to add another location and radius. As shown in FIG. 5, second zone 201 is set with a three mile radius centered on MacDill Air Force Base. Save button 250 is clicked and dialog box is refreshed to the view as shown in FIG. 6. As shown, the grid added another row so that two locations and two radiuses are provided to permit RDC mobile deposits in completely separate locations. In FIG. 7, a 100 mile radius is set over a point in Yemen to create third zone 202 which may encompass overseas military bases. Save button 250 is clicked and dialog box is refreshed to the view as shown in FIG. 8. In this embodiment of the invention, all three zones were created by circular shapes.

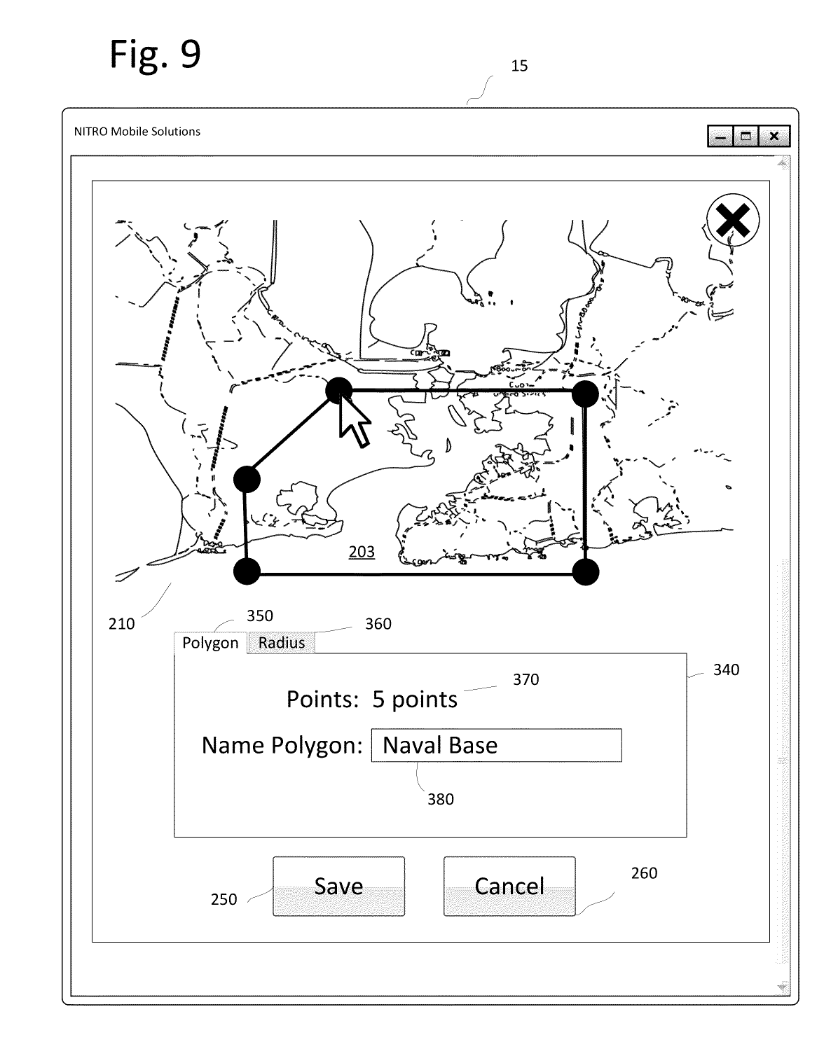

However, in FIG. 9, an alternative embodiment of the invention is shown having a panel 340 with polygon tab 350 and radius tab 360. The method of setting zones by a center-point and radius was shown in FIGS. 3, 5, and 7. However, in FIG. 9, fourth zone 203 is created by a five-point polygon. Label 370 counts the polygon points and textbox 380 enables the end user configuring the system to name the polygon with a descriptive string. Map 210 in FIG. 9 shows Guantanamo Bay, Cuba and polygon zone 203 is aligned to the United States-Cuba border. Permitting RDC within zone 203 will likely be considered secure while permitting RDC mobile deposits outside the zone may have a higher risk of fraud.

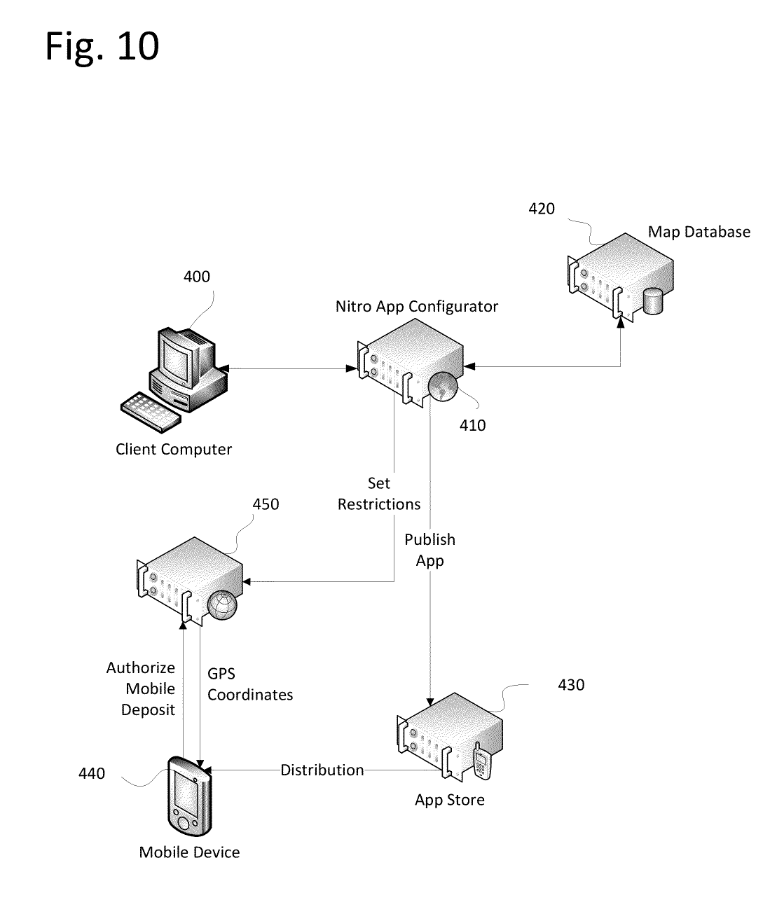

The method of an embodiment of the invention is shown in FIG. 10 wherein a client computer 400 is communicatively coupled via a secure connection to Nitro App Configurator 410. Configurator 410 in this instance is a web server such as IIS sold by MICROSOFT CORPORATION. As discussed in FIGS. 1-9, map data 420 is access to set various zones that permit or deny RDC mobile deposits. Once the configuration is satisfactory to the end user (here the bank representative) at client computer 400, a mobile app content is updated and the new configuration is pushed or pulled down to the installed application on the mobile device 440. A banking customer obtains the updated configuration for the mobile app and installs on his mobile device 440. In attempting a RDC mobile deposit GPS coordinates from mobile device 440 are sent to authentication server 450 which compares the GPS coordinates with the previously set restrictions and either authorizes or denies the mobile deposit.

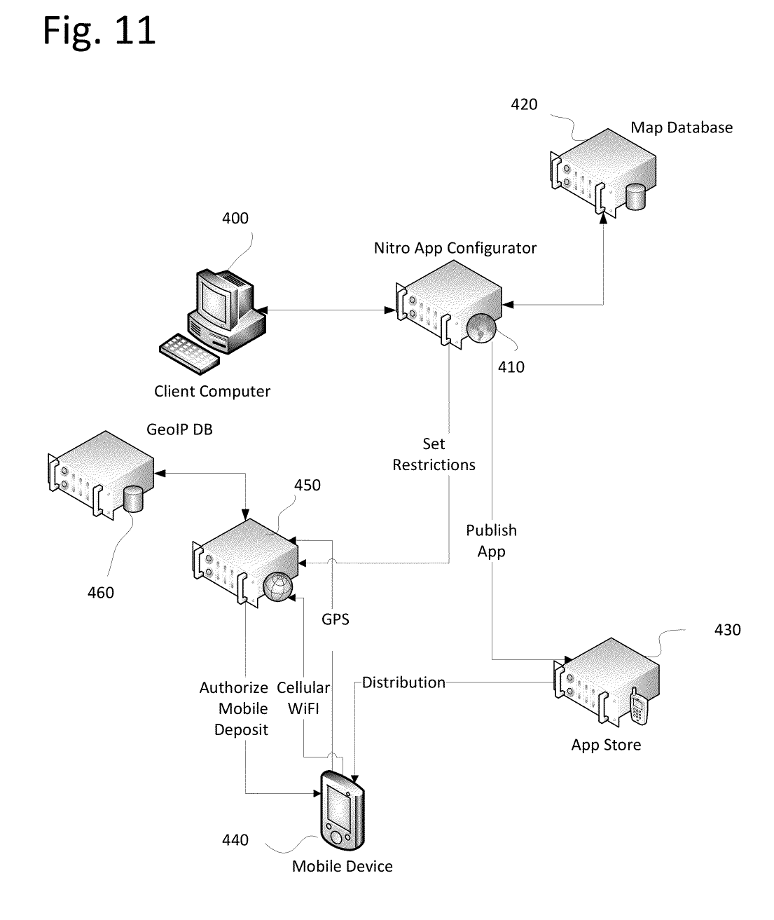

In an alternative embodiment of the invention as shown in FIG. 11, mobile device sends GPS coordinates and/or a collection of additional geolocation data. Such geolocation data may include the internet protocol IP address (either TCP/IP v4 or v6 standards) if connected through Wi-Fi. One geolocation approach is to identify the subject party's IP address, then determine the location, organization, or user the IP address has been assigned to, and finally, determine that party's location by cross-referencing the IP address with GeoIP database 460. Such databases are commercially available. One example is provided under the MAXMIND brand. Another type of geolocation data may include cellular geolocation.

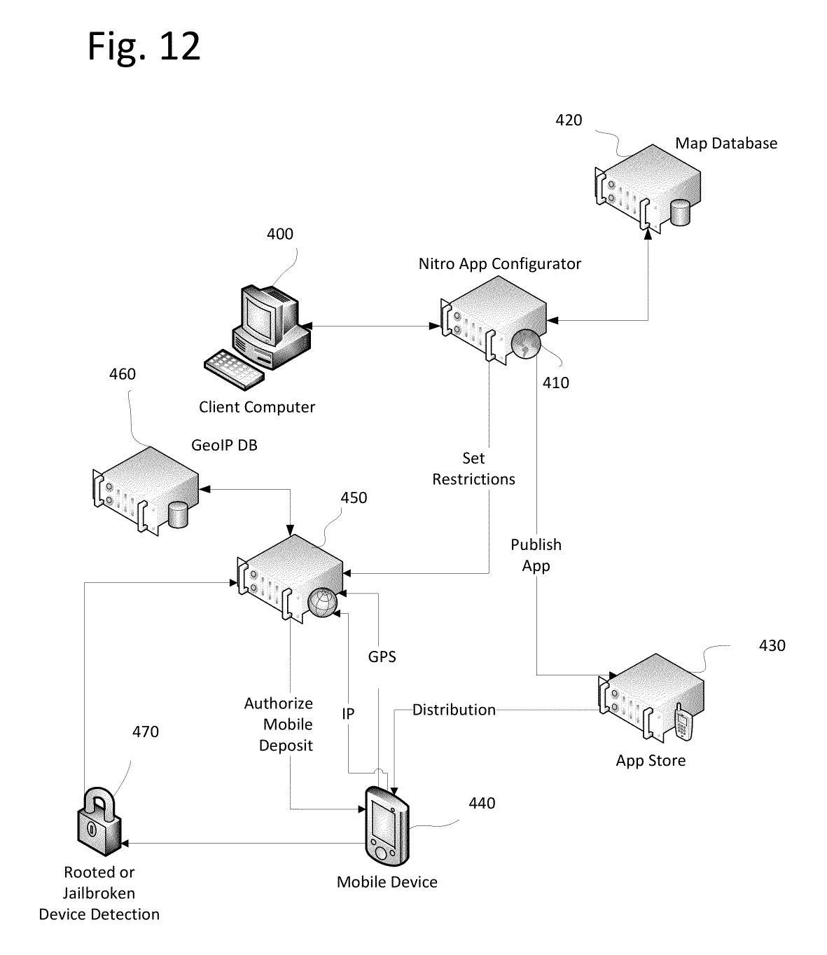

Yet another embodiment of the invention is shown in FIG. 12 wherein security module 470 detects whether mobile device 440 is rooted (ANDROID) or jail-broken (IOS).

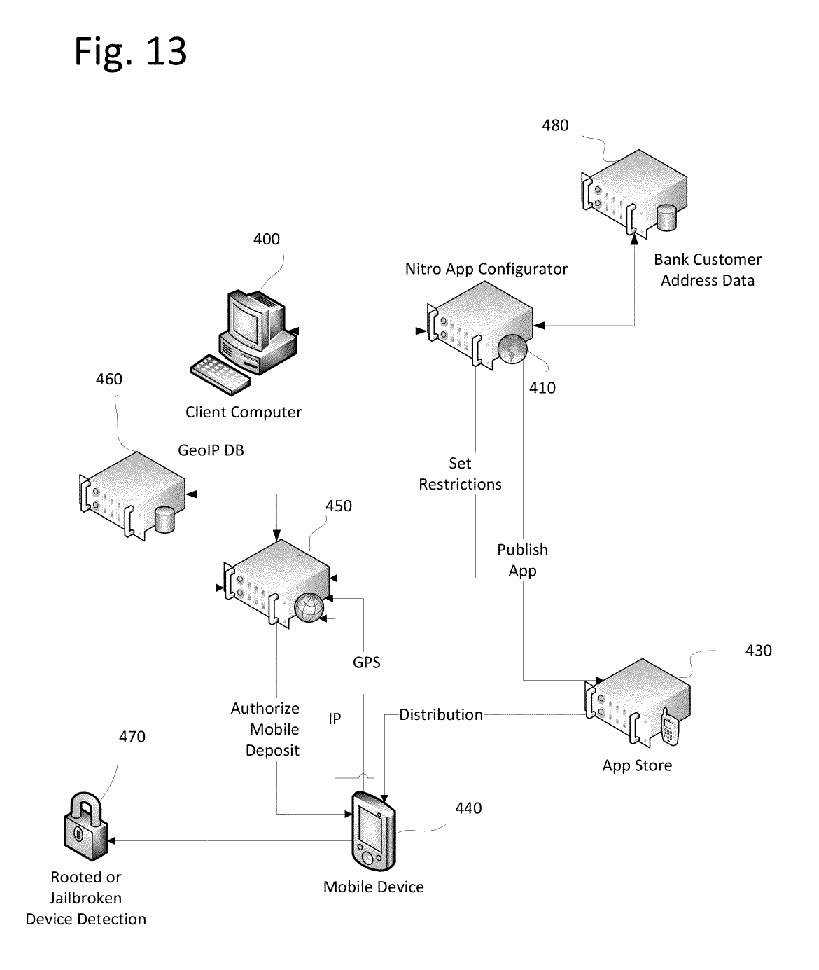

Finally, yet another embodiment of the invention is shown in FIG. 13 wherein RDC mobile deposit permitted zones are automatically set by referencing the bank customer's database of addresses. For example, bank may create a secure web service to configurator 410 which provides a raw list of addresses or even just ZIP codes in which its own banking customers operate. Configurator 410 automatically generates permitted RDC mobile deposit zones from this data. The data may be address-based such as street, city, state and/or zip code. Alternatively, it may also use telephone area codes to set zones as well. Some more highly secure features of the banking application may require authenticated locations close to a bank customer's home while others may have a higher tolerance. For example, RDC mobile deposits over $1,000 may require geolocation of mobile device 440 within 20 miles of a first zone while deposits under $1,000 may be permitted within 50 miles of the first zone. It is also contemplated that successful, fraud-free deposits are logged and automatically used to update the permitted zones of RDC mobile deposits. Alternatively, detected fraud at a specific location may automatically create a deny-zone around that area for either a predetermined period of time or until the deny-zone is manually lifted.

### Hardware and Software Infrastructure Examples

The present invention may be embodied on various computing platforms that perform actions responsive to software-based instructions. The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequency, etc., or any suitable combination of the foregoing. Computer program code for carrying out operations for aspects of the present invention may be written in any combination of one or more programming languages, including an object oriented programming language such as Java, C#, C++ or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a

particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

### GLOSSARY OF CLAIM TERMS

Android rooting is the process of allowing users of smartphones, tablets, and other devices running the Android mobile operating system to attain privileged control (known as “root access”) within Android's subsystem.

Geolocation (cellular) is less precise than by GPS, but it is available to devices that do not have GPS receivers and where the GPS is not available. Precision is highest where advanced forward link methods are possible (where a device is within range of at least three cell sites and where the carrier has implemented timing system use) and lowest where only a single cell site can be reached, in which case the location is only known to be within the coverage of that site. Another method using angle of arrival (AoA), possible when in range of at least two cell sites, produces intermediate precision.

Geolocation (IP address) works by automatically looking up an IP address on a WHOIS service and retrieving the registrant's physical address. IP address location data can include information such as country, region, city, postal/zip code, latitude, longitude and timezone. The primary source for IP address data is the regional Internet registries which allocate and distribute IP addresses amongst organizations located in their respective service regions.

Global Positioning System (GPS) is a space-based satellite navigation system that provides location and time information in all weather conditions, anywhere on or near the Earth where there is an unobstructed line of sight to four or more GPS satellites.

iOS jail-breaking is the process of removing the limitations on APPLE devices running the iOS operating system through the use of software and hardware exploits—such devices include the iPhone, iPod touch, iPad, and second generation APPLE TV. Jail-breaking permits root access to the iOS operating system, allowing the download of additional applications, extensions, and themes that are unavailable through the official APPLE APP STORE.

Wi-Fi-based positioning system is used where GPS is inadequate due to various causes including multipath and signal blockage indoors.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

1. A computer-based system for securing a mobile device, comprising:
a remotely accessible bank administrative portal for setting a plurality of geographic-based security rules;
a rules module communicative coupled to the bank administrative portal, the rules module comprising bank-definable geographic zones for enabling mobile deposit based on a plurality of remote geographic locations of the mobile device;
a geolocation module communicatively coupled to the rules module and communicatively coupled to the mobile device, the geolocation module receives both GPS and Geo-IP data of the mobile device combining the data as a two-factor authentication measure to determine an accurate location of the mobile device and applies said coordinates to the rules module to determine if mobile deposit features are enabled or disabled; and
an exception presentation module communicatively coupled to the rules module, the exception presentation module displaying notifications to the mobile device responsive to a disabling of the mobile deposit features responsive to the geolocation module reporting the mobile device falls outside the bank-definable geographic zones.

2. The system of claim 1 further comprising an operating system integrity module that disables one or more mobile deposit features responsive to a detection of a jail-broken or rooted mobile operating system.

3. (canceled)

4. The system of claim 1 further comprising a bank customer database containing address data for a plurality of bank customers, the bank customer database communicatively coupled to the rules module wherein the geographic zones are automatically generated based on the address data without user input.

5. The system of claim 1 further comprising a fraud alert module communicatively coupled to the rules module wherein responsive to a geographically identified fraud attempt, a blocked geographic zone is automatically generated centered on the location of the fraud attempt.

6. The system of claim 5 further comprising a predetermined wait constant accessible by the fraud alert module wherein the blocked geographic zone is disabled after a duration of time defined by the wait constant has expired after the fraud attempt was first identified.

7. The system of claim 6 further comprising a manual override routine to disable the blocked geographic zone prior to the expiration of the wait constant.

8. The computer-implemented server application of claim 1 further comprising a first predetermined threshold amount used in conjunction with a first geographic zone and a second predetermined threshold amount used in conjunction with a second geographic zone wherein the first amount is higher than the second amount and the first zone represents a lower fraud risk than the second zone.

9. The system of claim 8 wherein the first and second amounts are automatically derived from the current funds on deposit by a user attempting to make the mobile deposit.

10. The system of claim 8 wherein the first and second amounts are automatically derived from a banking history profile by a user attempting to make the mobile deposit, the banking history including the past frequency of check deposits made by the user previously.

11. A non-transitory computer medium that contains computer-executable instructions which when executed by a processor causes the processor to perform the steps of:
providing a remotely accessible encrypted bank administrative portal for configuring a mobile device application having a mobile deposit function to electronically capture images of a paper check and submit them for electronic deposit to a bank account;
configuring a plurality of geolocation rules on the administrative portal to permit or deny the mobile deposit function based on whether a mobile device running the application is within one of a plurality of geographic zones;
accessing a bank customer database containing electronic address data for a plurality of bank customers, the bank customer database communicatively coupled to the rules server wherein the geographic zones are automatically generated based on the electronic address data;
configuring a device rule on the administrative portal to permit or deny the mobile deposit function based on whether the mobile device running the application has been rooted or jail-broken;
publishing the configured changes to an app for customers of a bank;
establishing a secure connection between the application installed on the customer's mobile device and a rules server storing configuration data set by the administrative portal;
through the secure connection detecting whether the customer's mobile device has been rooted or jail-broken to deny the mobile deposit function; and
through the secure connection detecting whether the location of the customer's mobile device permits or denies a mobile deposit attempt.

12. (canceled)

13. The medium of claim 11 further comprising the step of providing a fraud alert module communicatively coupled to the rules server wherein responsive to a geographically identified fraud attempt, a blocked geographic zone is automatically generated centered on the location of the fraud attempt.

14. The medium of claim 13 further comprising the step of providing a predetermined wait constant accessible by the fraud alert module wherein the blocked geographic zone is disabled after a duration of time defined by the wait constant has expired after the fraud attempt was first identified.

15. The medium of claim 14 further comprising the step of providing a manual override routine to disable the blocked geographic zone prior to the expiration of the wait constant.

16. The method of claim 11 further comprising the step of providing a first predetermined threshold amount used in conjunction with a first geographic zone and a second predetermined threshold amount used in conjunction with a second geographic zone wherein the first amount is higher than the second amount and the first zone represents a lower fraud risk than the second zone.

17. The medium of claim 16 wherein the first and second amounts are automatically derived from the current funds on deposit by a user attempting to make the mobile deposit.

18. The medium of claim 16 wherein the first and second amounts are automatically derived from a banking history profile by a user attempting to make the mobile deposit, the banking history including the past frequency of check deposits made by the user previously.

19. A non-transitory computer medium that contains computer-executable instructions which when executed by a processor causes the processor to perform the steps of:
providing a remotely accessible encrypted bank administrative portal for configuring a mobile device application having a mobile deposit function to electronically capture images of a paper check and submit them for electronic deposit to a bank account;
automatically setting a plurality of geolocation rules on the administrative portal to permit or deny the mobile deposit function based on whether a mobile device running the application is within one of a plurality of geographic zones set within the administrative portal, the setting of the geographic zones is automated by accessing a bank customer database containing electronic address data for a plurality of bank customers, the bank customer database communicatively coupled to the rules server wherein the geographic zones are automatically generated based on the electronic address data;
configuring a device rule on the administrative portal to permit or deny the mobile deposit function based on whether the mobile device running the application has been rooted or jail-broken;
publishing the configured changes to the mobile application.
establishing a secure connection between the application installed on the customer's mobile device and a rules server storing configuration data set by the administrative portal;
through the secure connection detecting whether the customer's mobile device has been rooted or jail-broken to deny the mobile deposit function;
through the secure connection detecting whether the location of the customer's mobile device permits or denies a mobile deposit attempt, wherein the detecting of the location includes a geolocation module receiving both GPS and Geo-IP data of the mobile device and combining the data as a two-factor authentication measure to determine an accurate location of the mobile device; and
providing fraud alert module communicatively coupled to the rules server wherein responsive to a geographically identified fraud attempt, a blocked geographic zone is automatically generated centered on the location of the fraud attempt.

20. The method of claim 11, wherein the step of detecting whether the location of the customer's mobile device permits or denies a mobile deposit attempt, includes a geolocation module receiving both GPS and Geo-IP data of the mobile device and combining the data as a two-factor authentication measure to determine an accurate location of the mobile device
